(19) United States
(12) Patent Application Publication
(10) Pub. No.: US 2011/0100097 A1
(43) Pub. Date: May 5, 2011

(54) Leakage Seeker

(76) Inventors: Ludolf Gerdau, Elsdorf (DE); Randolf Paul Rolff, Horrem (DE); Norbert Rolff, Horrem (DE); Daniel Wetzig, Koln (DE)

(21) Appl. No.: 12/309,567

(22) PCT Filed: Jul. 2, 2007
(86) PCT No.: PCT/EP2007/056639

§ 371 Date: Jan. 18, 2011

(30) Foreign Application Priority Data
Jul. 27, 2006 (DE) 10 2006 034 735.8

(51) Int. Cl. G01M 3/20

(52) U.S. Cl. 73/40.7

(57) ABSTRACT

A leak detector having a pre-vacuum feed pump, a gas detector and a flow sensor. The detector also includes a buffer volume and a restrictor to be arranged between the feed pump and the flow sensor. This protects the flow sensor against pressure surges generated by the feed pump.

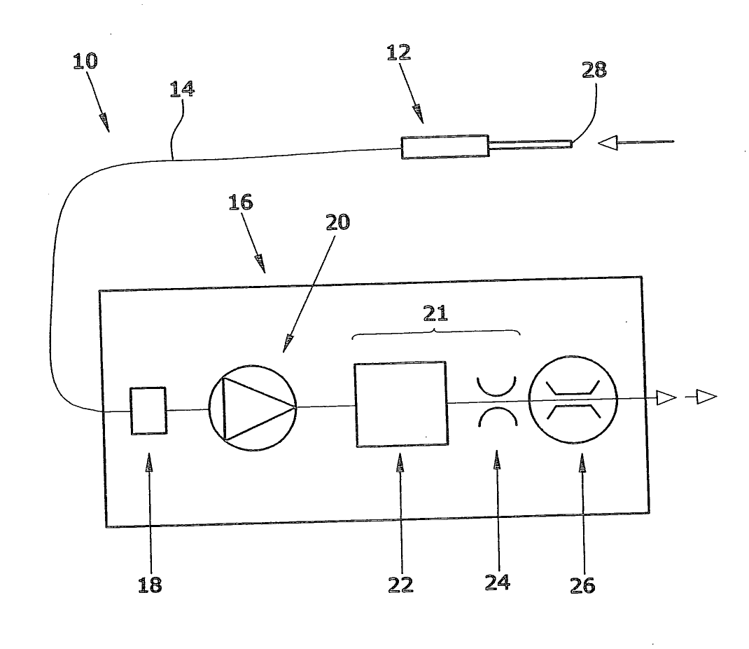

### BACKGROUND

1. Field of the Invention

The disclosure relates to a leak detector comprising a pre-vacuum feed pump, a gas detector and a flow sensor.

2. Discussion of the Background Art Leak detectors, also referred to as leak sniffing devices, are used for scanning a test item containing a test gas. If a gas leak exists, the test gas will evade from the test item to the outside. The test gas will be detected by the gas detector or gas sensor and be reported. The pre-vacuum feed pump has the function of continuously conveying gas from the vicinity of the test item and to supply said gas to the gas detector.

In the gas path, a flow sensor for detecting the gas flow is arranged upstream or downstream of the feed pump. On the one hand, the flow sensor is operative to perform a controlling and monitoring function, i.e. for controlling whether the conveying path is possibly clogged and, respectively, whether the feed pump is working without disturbances. On the other hand, the flow sensor is operative to detect the flow rate and, in cases where test gas is present, to detect the concentration of the test gas in the conveyed gas, or to detect the leakage rate.

Practice has shown that the flow sensor is a relatively vulnerable component which is susceptible to frequent damage.

In view of the above, it is an object of the disclosure to provide a leak detector whose flow sensor is better protected from damage.

### SUMMARY

In the leak detector of the disclosure, a gas buffer volume and a gas restrictor are arranged between the feed pump and the flow sensor. By the arrangement of a buffer volume and a restrictor between the feed pump and the flow sensor, pressure surges of the feed pump are attenuated and smoothed on the way to the flow sensor. Pressure surges of the feed pump are caused upon switch-on and switch-off of the feed pump but are caused particularly by the feed pump during the conveying process, especially in case of displacement pumps designed for discontinuous conveyance of gas.

With respect to fast pressure surges, the flow sensor is isolated from the feed pump by the arrangement of buffer volume and restrictor, said arrangement forming a low pass. Thereby, the flow sensor will be protected in a simple and inexpensive manner from the main cause of damages of the flow sensor.

Preferably, the buffer volume, when viewed in relation to the restrictor, is arranged on the side of the pump. In other words, the buffer volume is always located between the restrictor and the feed pump, irrespective of whether, when seen in flow direction, the arrangement of buffer volume, restrictor and flow sensor is situated upstream or downstream of the feed pump. Only in this configuration, the buffer volume and the restrictor can act as a low pass in relation to the feed pump.

Preferably, the flow sensor is arranged on the outlet side of the feed pump. In this manner, also pressure surges introduced into the leak detector from outside via a sniffing opening can be kept away from the flow sensor because, between the flow sensor and the sniffing opening, the feed pump as well as the buffer volume and the restrictor are arranged.

The volume of the buffer volume is preferably at least three times as large as the pumping volume of the feed pump. This provision is based on a feed pump of the type for discontinuous conveyance which, when operated, will generate corresponding pressure surges. According to a particularly preferred embodiment, the feed pump is formed as a displacement pump for exclusively discontinuous conveyance. Displacement pumps, e.g. membrane pumps, are simple in construction as well as robust and inexpensive, and thus find preferred application as feed pumps in leak detectors.

By sizing the buffer volume to be at least three times as large as the pumping volume of the feed pump, it is safeguarded that the pressure surges generated by the feed pump will be largely damped, so that the flow sensor can be sufficiently protected from the pressure surges caused by the feed pump during operation.

Preferably, the pressure drop at the restrictor is smaller than 100 mbar, more preferably smaller than 70 mbar. In this manner, the pressure surges generated by the feed pump with stroke frequency will be reliably filtered by the arrangement comprising the buffer volume and the restrictor. The stroke frequency of the feed pump is defined—in a feed pump configured as a displacement pump—as the frequency at which the pumping volume will be conveyed per time unit. The stroke frequency is identical with the rotary frequency of the feed pump if a single pumping volume is conveyed per rotation of the drive shaft or if a plurality of serially connected pumping volumes are conveyed. In cases, however, where the feed pump comprises a plurality of pumping volumes connected in parallel, the stroke frequency will be a corresponding multiple of the rotary frequency of the feed pump.

According to a preferred embodiment, there is provided at least one further arrangement of buffer volume and restrictor. This buffer-volume/restrictor arrangement can be located immediately adjacent to the first buffer-volume/restrictor arrangement but can also be located separately from the first arrangement. By the provision of a second buffer-volume/restrictor arrangement, the filter parameters of the overall arrangement comprising said two buffer-volume/restrictor arrangements can be still better adapted to the requirements. If the flow sensor is arranged between the sniffing opening and the feed pump, the second buffer-volume/restrictor arrangement can be located between the sniffing opening and the flow sensor while the first buffer-volume/restrictor arrangement is arranged between the feed pump and the flow sensor. Thereby, given this placement of the flow sensor, the latter will be protected from pressure surges towards both sides.

Preferably, the flow sensor is a micromechanical flow sensor. Further, the flow sensor can be a thermal flow sensor. Micromechanical flow sensors are relatively inexpensive and precise, particularly if designed as thermal flow sensors. However, micromechanical flow sensors are very vulnerable towards pressure surges. The use of the buffer-volume/restrictor arrangement makes it possible to utilize micromechanical thermal flow sensors without deterioration of the reliability of the leak detector caused by the micromechanical thermal flow sensor.

### BRIEF DESCRIPTION OF THE DRAWINGS

An embodiment of the disclosure will be explained in greater detail hereunder with reference to the drawing.

The FIGURE is a schematic view of a leak detector.

### DETAILED DESCRIPTION OF THE PREFERRED EMBODIMENT

Shown in the FIGURE is a leak detector 10 substantially consisting of a handpiece 12, a sniffing line 14 and a detection unit 16. Detection unit 16 comprises—in serial arrangement—a gas detector 18, a feed pump 20, a buffer volume 22, a restrictor 24 as well as a flow sensor 26.

Said handpiece 12 is also referred to as a sniffing probe and on its distal end is provided with a sniffing opening 28 for suctional intake of gas. Via the sniffing line 14 which is formed as a flexible tube, the sucked gas will flow to the gas detector 18 which is operative to detect a test gas such as e.g. helium in the sucked gas, in case that test gas is present. Gas detector 18 can be configured as a mass spectrometer, for instance.

Feed pump 20 is a pre-vacuum feed pump formed as a displacement pump, e.g. as a membrane pump. Displacement pumps inherently generate pressure surges during the opening and closing of the pumping chamber. Feed pump 20 generates a volume flow of about 150 cm³/s. Feed pump 20 is followed by said buffer volume 22 which has a volume at least three times as large as the pumping volume of feed pump 20. The volume of feed pump 20 can be e.g. 10 cm³. The volume of buffer volume 22 can then be 50 cm³, for instance. Arranged downstream of the buffer volume is the restrictor 24 where a pressure drop of less than 100 mbar, preferably less than 70 mbar, will occur.

Restrictor 24 finally is followed by flow sensor 26 which is configured as a micromechanical thermal flow sensor. Flow sensors of this type are vulnerable towards pressure surges as generated e.g. upon switch-on and switch-off of feed pump 20 but also each time that the pumping volume of feed pump 20 is opened and closed.

Flow sensor 26 is provided for function control of the feed pump, for detection of clogging of the overall gas conveyance path, and for quantification of the gas flow, said quantification of the gas flow in turn allowing for detection of the test gas concentration and respectively the leakage rate in case that the presence of test gas has been sensed.

The limiting frequency of the arrangement 21 of buffer volume 22 and restrictor 24 is smaller than half the stroke frequency of feed pump 20. This reliably provides for a sufficient damping of the feed pump in relation to its stroke frequency.

Downstream of the flow sensor, the gas will leave the detection unit 16 via an exhaust.

Flow sensor 26 in the present embodiment is arranged on the outlet side of feed pump 20. In principle, however, flow sensor 26 can also be arranged on the inlet side of feed pump 20. In the latter case, in order to preclude that pressure surges generated by feed pump 20 might be transmitted to the flow sensor, a corresponding arrangement of buffer volume and restrictor has to be located between the feed pump and the flow sensor, wherein the buffer volume, when seen relative to the restrictor, is always arranged on the feed pump side.

What is claimed is:

1. A leak detector comprising a pre-vacuum feed pump, a gas detector and a flow sensor,
wherein a buffer volume and a restrictor are arranged between the feed pump and the flow sensor.

2. The leak detector according to claim 1, wherein the buffer volume, when seen relative to the restrictor, is arranged on the pump side.

3. The leak detector (10) according to claim 1, wherein the flow sensor is arranged on the outlet side of the feed pump.

4. The leak detector according to claim 1, wherein the volume of the buffer volume is at least three times as large as the pumping volume of the feed pump.

5. The leak detector according to claim 1, wherein the limiting frequency of the arrangement of buffer volume and restrictor is smaller than half the stroke frequency of the feed pump.

6. The leak detector according to claim 1, wherein the pressure drop at the restrictor is less than 100 mbar.

7. The leak detector according to claim 1, wherein at least one further arrangement of buffer volume and restrictor is provided.

8. The leak detector according to claim 1, wherein the feed pump is a displacement pump.

9. The leak detector according to claim 1, wherein the flow sensor is a micromechanical flow sensor.

10. The leak detector according to claim 1, wherein the flow sensor is a thermal flow sensor.
